(19) United States
(12) Patent Application Publication
(10) Pub. No.: US 2015/0186906 A1
(43) Pub. Date: Jul. 2, 2015

(54) CONTRACT CAPACITY OPTIMIZING SYSTEM AND OPTIMIZING METHOD FOR USING THE SAME

(71) Applicant: DELTA ELECTRONICS, INC., Taoyuan County (TW)

(72) Inventors: Meng-Seng CHEN, Taoyuan County (TW); Tien-Szu LO, Taoyuan County (TW)

(73) Assignee: DELTA ELECTRONICS, INC., Taoyuan County (TW)

(21) Appl. No.: 14/276,586

(22) Filed: May 13, 2014

(30) Foreign Application Priority Data
Dec. 27, 2013 (TW) 102148596

(51) Int. Cl. G06Q 30/02; G06Q 50/06

(52) U.S. Cl. CPC G06Q 30/0202; G06Q 50/06

(57) ABSTRACT

An optimizing system for contract capacity includes a processing unit, an input unit and a database. The processing unit accesses history data related to past energy consumption of a building, and receives future plan data related to future strategies of the building. The processing unit predicts a one or multiple of predicted-peak demand for each time section of each past month of the building based on the history data and the future plan data. Further, the processing unit receives a user demand, and computes an optimized contract capacity which satisfies the user demand based on the predicted-peak demand. Thus, the optimizing system obtains the contract capacity which satisfies the user demand and generates lowest total electricity bill of the building. The optimized contract capacity is useful to a user when signing contracts with the electricity company.

### BACKGROUND OF THE INVENTION

1. Field of the Invention

The present invention relates to an optimizing system and an optimizing method, in particular relates to an optimizing system and an optimizing method for computing an optimizing contract capacity.

2. Description of Related Art

The operators having high power consumption demand, such as companies, factories, department stores, construction companies etc., generally sign a contract with the electricity company for defining a demand charge and demanding that the power consumption cannot exceed instantaneous kilowatts (i.e. the so called peak demand or maximum demand) or total power consumption cannot exceed a specific value during a billing period, which is the so called contract capacity. Otherwise the operators have to pay a penalty charge according to the contract. Accordingly, in the skilled art of the present invention, there are technologies available for helping the operators to calculate preferred and more reasonable contract capacities as the reference for signing the contract of the following year with the electricity company.

These related technologies calculate preferred contract capacities only based on algorithms. For example, the algorithms analyze the power consumption information according to the power consumption history data of the past year in the building, and generate, after calculation, a suggesting contract capacity for the following year. Nonetheless, there are many factors impacting power consumption in a building, for example the indoor people counts, the outdoor temperatures, etc. It is difficult to precisely predict the expected total power consumption of the following year and the peak demand using only the last power consumption information as the analysis basis without knowing the reason contributing to the high/low power consumption last year. Thus, it is a challenge to generate a precise contract capacity by the above calculation scheme. If operators sign contracts with the electricity company according to the imprecise contract capacity, it is possible the contract capacity is not utilized in reality in the following year and the cost becomes wasted, or the power consumption in reality may exceed the contract capacity too much resulting in tremendous penalty charges.

### SUMMARY OF THE INVENTION

The objective of the present invention is to provide a contract capacity optimizing system and optimizing method for predicting potential predicted-peak demand of the following year in a building based on history data of the electricity usage in the building and future strategies of the building, such that the system further precisely calculates the optimizing contract capacity of the following year in the building based on the predicted-peak demand as the reference to users for signing the contract with the electricity company.

The another objective of the present invention is to provide a contract capacity optimizing system and optimizing method, which receives the user demand such that the system calculates the contract capacity of the following year generating lowest energy charge and matching with the user demand.

In order to achieve the above objectives, the present invention discloses a contract capacity optimizing system comprising a processing unit, an input unit and a database, and an optimizing method used by the optimizing system. The processing unit retrieves history data related to past power consumption of the building from the database, and receives future plan data related to future strategies of the building from the input unit. The processing unit predicts a predicted-peak demand of each time section of each month in the following year in the building based on the history data and the future plan data. Next, the processing unit receives a user demand from the input unit, and calculates an optimizing contract capacity matching with user demand based on the calculated predicted-peak demand.

The present invention uses both history data and future strategies of a building, first predicting a potential predicted-peak demand of the following year, and calculating a contract capacity of the following year based on the calculated predicted-peak demand. The present invention improves the imprecision issue of the related art using only history data as the predicting basis for calculating the contract capacity of the following year.

Further, the objective of the optimizing contract capacity is to minimize the payable total electricity fee of the following year via planning. Nonetheless, the total electricity fee generally comprises a basic charge and a penalty charge. It is possible the mode that the basic charge is largely reduced but the penalty charge is required which accounts for a total electricity fee is further lower than the mode that pays a higher basic charge without any penalty charge. Consequently, the total payable electricity fee is saved, but the penalty charge would be high and the administrator may have negative impression on the user. Further, the calculation errors may result in increasing contract exceeding months, which generates a higher total electricity fee in reality. Thus, when calculating a contract capacity of the following year, the present invention further takes a user demand into account for optimizing a contract capacity of the following year in accordance with user demand.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a system block diagram of the first embodiment according to the present invention;

FIG. 2 is an optimizing architecture schematic diagram of the first embodiment according to the present invention;

FIG. 3 is history data schematic diagram of the first embodiment according to the present invention;

FIG. 4 is future plan data schematic diagram of the first embodiment according to the present invention;

FIG. 5 is an optimizing flowchart of the first embodiment according to the present invention; and

FIG. 6 is an optimizing architecture schematic diagram of the second embodiment according to the present invention.

### DETAILED DESCRIPTION OF THE INVENTION

In cooperation with attached drawings, the technical contents and detailed description of the present invention are described thereinafter according to a preferable embodiment, being not used to limit its executing scope. Any equivalent variation and modification made according to appended claims is all covered by the claims claimed by the present invention.

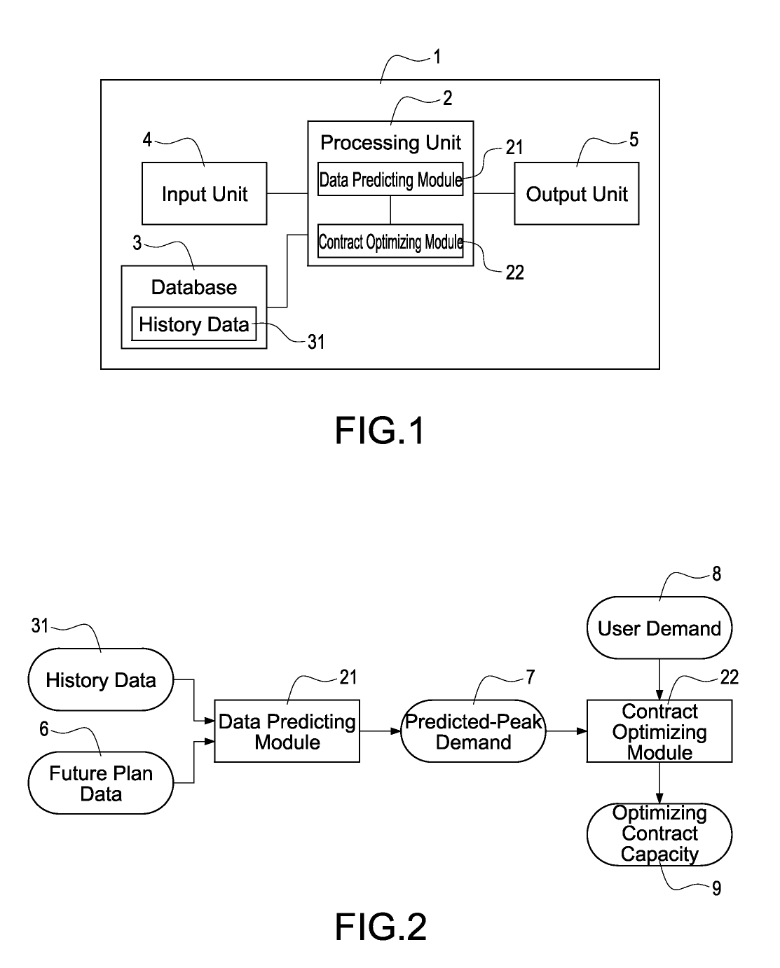

FIG. 1 and FIG. 2 are a system block diagram and an optimizing architecture schematic diagram of the first embodiment according to the present invention. The present invention discloses a contract capacity optimizing system (referred as the system 1), the system 1 comprises a processing unit 2, a database 3, an input unit 4 and an output unit 5, wherein the processing unit 2 electrically coupled to the database 3, the input unit 4 and the output unit 5.

In the embodiment, the system 1 is installed in a building (not shown in the diagrams), and can be a Building Energy Management System (BEMS) in the building, or integrated with the existed BEMS of the building, but is not limited thereto.

History data 31 related to past power consumption of the building is recorded in the database 3. In a preferred embodiment, the history data 31 related to last year power consumption of the building is recorded in the database 3. In other embodiments, complete records of history data 31 in the past several years related to power consumption of the building in the database 3, but is not limited thereto. The processing unit 2 obtains the history data 31 from the database 3, and receives data related to future operation strategies of the building from the input unit 4, which are external inputs by a user. Thus, the processing unit 2 predicts a potential peak demand of the building in the future, and further calculates an optimizing contract capacity which is displayed or outputted via the output unit 5. In a preferred embodiment, the processing unit 2 receives data related to operation strategies in the following year of the building via the input unit 4, which is used as a basis for predicting potential peak demand of the following year in the building, but is not limited thereto. The present invention predicts the potential peak demand in the future, and calculates the optimizing contract capacity via the processing unit 2, which facilitates the user of the building to sign a contract with the electricity company (the contract of the following year).

As shown in FIG. 2, in the embodiment, the processing unit 2 comprises a data predicting module 21 and a contract optimizing module 22, wherein the contract optimizing module 22 connects to the data predicting module 21. The data predicting module 21 obtains the history data 31 related to past power consumption from the database 3, and the data predicting module 21 receives future plan data 6 of the building from the input unit 4, which is an external input. The data predicting module 21 predicts a predicted-peak demand 7 of the building in the future based on the history data 31 and the future plan data 6.

It should be noted is the quantity of the predicted-peak demand 7 and the corresponding time sections of the predicted-peak demand 7 in the embodiment, correspond to the quantity of the history data 31 and the corresponding time sections of the history data 31. For example, if the history data 31 comprises all data of one year or several years in the past, the data predicting module 21 predicts predicted-peak demand 7 of each month of different time sections in the whole last year.

The contract optimizing module 22 obtains the predicted-peak demand 7 from the data predicting module 21, and calculates an optimizing contract capacity 9 via algorithm. The optimizing contract capacity 9 is displayed and outputted via the output unit 5, such that the user signs a contract with the electricity company according to content of the optimizing contract capacity 9.

In another embodiment, the contract optimizing module 22 receives a user demand 8 which is an external input from the input unit 4. When calculating the optimizing contract capacities 9, one or several contract capacities which are not matching with the user demand 8 are excluded, and the contract capacity generating lowest electricity fee is selected as the optimizing contract capacity 9 among one or several contract capacities which are matching with the user demand 8.

Substantially, when the contract optimizing module 22 calculates the optimizing contract capacity 9, the contract optimizing module 22 considers being matching with the user demand 8 as the first requirement and considers the amount of the electricity fee as the second requirement. For example, providing a calculated contract capacity A saves more electricity fee than a contract capacity B, if the contract capacity A is not matching with the user demand 8 and the contract capacity B is matching with the user demand 8, the contract optimizing module 22 then considers the contract capacity B as the optimizing contract capacity 9. In the embodiment, the user demand 8 is the contract exceeding month maximum acceptable by the user (detailed in the following), but is not limited thereto.

Generally speaking, the total electricity fee includes a basic charge and a penalty charge, and only when the peak demand exceeds the content of the contract capacity, the penalty charge is required. In other words, even if the penalty charge is required because of exceeding the contract, as long as the basic charge is low, the total electricity fee could be the lowest. Thus, an optimized contract capacity generates the lowest total electricity fee, but the decrease of the total electricity fee results from lowering the basic charge. Given the user purposely lowers the basic charge of certain months, and exceeds the contract in a month or several other months. Under the circumstance, the total energy charge may be lower, but the quantity of the contract exceeding months is higher, which delivers bad impression of the user, or gives the impression that the user has inefficient control of power consumption from a third person perspective. Accordingly, via the present invention, the user is allowed to set up the user demand 8 (i.e., acceptable contract exceeding month maximum). Thus, the system 1 calculates the optimizing contract capacity 9 which matches with the user demand 8 as a requirement.

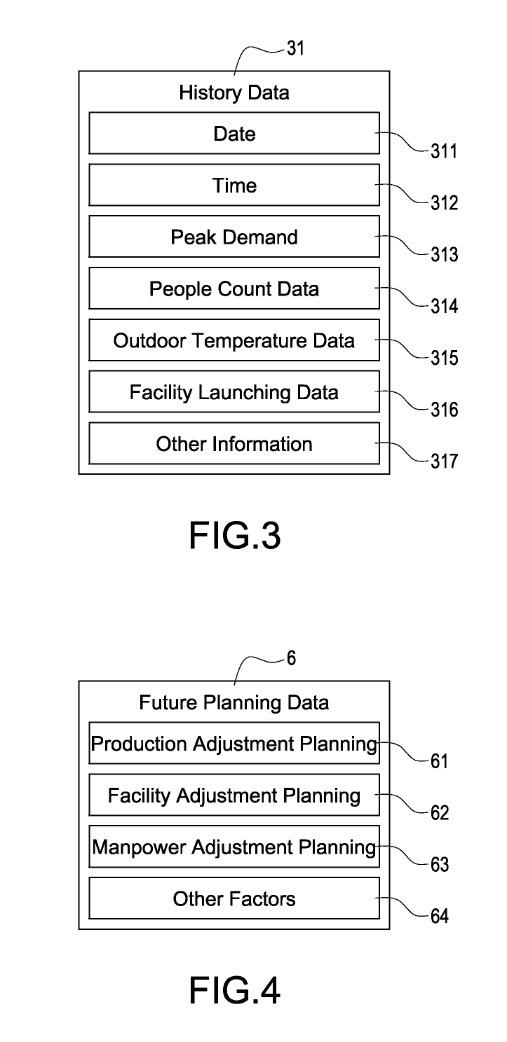

FIG. 3 is history data schematic diagram of the first embodiment according to the present invention. As shown in FIG. 3, in the embodiment, the history data 31 comprises date 311, time 312, a peak demand 313, people count data 314, outdoor temperature data 315, facility launching data 316 and other information (for example humidity) 317 etc. In the present invention, the data predicting module 21 predicts the predicted-peak demand 7 of the following year in the building based on the peak demand 313 in the history data 31, combining with the future plan data 6 inputted by the user. The amount of peak demand 313 depends on power consumption of the building, and the power consumption depends on different features of the building (such as the people count data 314, the outdoor temperature data 315, the facility launching data 316 and the other information 317 etc.). Therefore, in the present invention, the system 1 records above data via the database 3, and the data predicting module 21 takes all the data into accounts when predicting the predicted-peak demand 7.

For example, when the people count increases in the building, the air conditioners are required to balance and maintain the indoor temperature in order to maintain the same indoor temperature and generates a higher electricity fee and a higher peak demand 313. In another example, when outdoor temperature of the building decreases, the outdoor temperature lowers the indoor temperature, the operation temperature of the air conditioners can be lower or part of the air conditioners can be turned off or all of the air conditioners can be turned off in order to lower the electricity fee and reduces the peak demand 313. The relationships of the data are illustrated in the Table 1 in the following.

TABLE 1

| | | | | | air | | | | |
|---|---|---|---|---|---|---|---|---|---|
| | | | | lighting | conditioners | | | | |
| date | | | peak | power | power | other power | people | outdoor | |
| month | day | time | demand | consumption | consumption | consumption | count | temperature | humidity |
| 8 | 23 | 12:00 | 2544 | 12% | 51% | 37% | 255 | 36 | 60% |
| 9 | 15 | 15:45 | 2305 | 15% | 42% | 43% | 250 | 33 | 50% |

. . .

| | | | | | | | | | |
|---|---|---|---|---|---|---|---|---|---|
| 12 | 9 | 9:20 | 2200 | 15% | 42% | 43% | 210 | 22 | 80% |

In the example shown in the Table 1, because the outdoor temperature in August is higher, and the power consumption of the air conditioner is higher than other months, which leads to a higher peak demand of the month. Also, the power consumption in September and December is the same, yet the people count of the building and the outdoor temperature and humidity are higher in September. As a result, the peak demand is higher in September than in December. Yet, the above mentioned is a preferred embodiment of the present invention, and the scope of the invention is not limited thereto.

As shown in Table 1, the example demonstrated has a peak demand 313 each month. However, each country uses different billing method of electricity fees. For example, there are different time sections such as peak time sections (comprising summer peak time sections and non-summer peak time sections), Saturday half peak time sections, off-peak time sections in each month in Taiwan. Accordingly, the history data 31 comprises multiple entries of the peak demand 313 distinguished according to the date 311 and the time 312. The multiple entries of peak demand 313 respectively correspond to each time section of each past month. In the embodiment, the data predicting module 21 predicts multiple entries of the predicted-peak demand 7 based on the multiple entries of peak demand 313, combining with the future plan data 6. The multiple entries of the predicted-peak demand 7 respectively correspond to different time sections of each month in the future (generally n the following year). In addition, in the embodiment, the contract optimizing module 22 calculates multiple entries of the optimizing contract capacity 9 matching with the user demand 8 based on the multiple entries of the predicted-peak demand 7. The multiple entries of optimizing contract capacity are respectively applicable to the contracts of different time sections in order to achieve the objective of generating lowest basic charge.

For example, if the multiple entries of the peak demand 313 of the peak time sections and the off-peak time sections of each month in the past five years (i.e., 120 entries of the peak demand 313) are recorded in the history data 31, the data predicting module 21 predicts the multiple entries of the predicted-peak demand 7 of the peak time sections and the off-peak time sections of each month of the following year in the building (i.e. there are 24 entries of the predicted-peak demand 7). Lastly, the contract optimizing module 22 calculates two entries of the optimizing contract capacity 9 matching with the user demand 8, and the two entries of the optimizing contract capacity 9 are respectively applicable to a peak time section contract and an off-peak time section contract.

As shown in above mentioned embodiment and Table 1, the people count data 314, the outdoor temperature data 315, the facility launching data 316 and the other information 317 are recorded at the date and time as the multiple entries of peak demand 313 of the history data 31 were recorded. Thus, when the data predicting module 21 predicts the predicted-peak demand 7 of a certain time section of a certain month of the following year in the building, the precision of the predicted data is improved.

FIG. 4 is future plan data schematic diagram of the first embodiment according to the present invention. As shown in the diagram, in the embodiment, the future plan data 6 comprises a production adjustment plan 61, a facility adjustment plan 62, a manpower adjustment plan 63 and other factors 64 etc. The production adjustment plan 61 corresponds to the future facility usage rate of the building. For example, if the building is a factory, and the production capacity of the factory in the following year increases/decreases, the facility usage rate of the building in the following year would be increase/decrease. Consequently, the data predicting module 21 compares the current usage rate (according to the facility launching data 316) and future usage rate (according to the production adjustment plan 61), and uses the compared result as one of the predicting parameters.

The facility adjustment plan 62 corresponds to the future facility quantity and the facility performance of the building. For example, if the factory purchases/discards facilities in the following year, the facility quantity of the factory in the following year would increase/decrease. Consequently, the data predicting module 21 compares the current facility quantity (according to the facility launching data 316) with future facility quantity (according to the facility adjustment plan 62), and the compared result is used as one of the predicting parameters. Further, if the factory will replace several facilities of low efficiency with facility of high efficiency, the factory facility performance in the following year will increase. Consequently, the data predicting module 21 compares the current performance with the future performance, and the compared result is used as one of the predicting parameters.

The manpower adjustment plan 63 corresponds to a total people count of the building in the future. For example, if there will be n people increase/m people decrease in the factory, the total people count of the following year in the factory will increase/decrease. Accordingly, the data predicting module 21 compares the current total people count (according to the people count data 314) and the total future people count (according to the manpower adjustment plan 63), and the compared result is used as one of the predicting parameters.

The other factors 64 can be for example, future temperatures, humidity etc. predicting environmental factors, and the data predicting module 21 compares the current environmental factors (according to the other information 317) and the environmental factors (according to the other factors 64), and the compared result is used as one of the predicting parameters. Yet, the above mentioned is a preferred embodiment of the present invention, and the scope of the invention is not limited thereto.

In conclusion, in a preferred embodiment of the present invention, the data predicting module 21 predicts one or multiple entries of the predicted-peak demand 7 based on parameters of the multiple entries of peak demand 313, the multiple entries of the people count data 314, the multiple entries of the outdoor temperature data 315, the multiple entries of facility launching data 316, the multiple entries of other information 317, the production adjustment plan 61, the facility adjustment plan 62, the manpower adjustment plan 63 and the other factors 64 etc. Further, the contract optimizing module 22 calculates the optimizing contract capacity 9 matching with the user demand 8 and corresponding to one or several time sections based on one or multiple entries of the predicted-peak demand 7.

It should be noted is the calculating methods of electricity fees in each country are different. If a certain country applies a flat electricity fee without distinguishing time sections, the present invention calculates one entry of the optimizing contract capacity 9 matching with the user demand 8. On the other hand, if multiple time sections (for example, four time sections are used in Taiwan) are used for billing electricity fee, and the present invention calculates four entries of the optimizing contract capacities 9 matching with the user demand 8 and corresponding to the four time sections. The formula for calculating one or several entries of the optimizing contract capacity according to the present invention listed below:

$$z ( {x}_{1} , {x}_{2} , … , {x}_{n} ) = {\sum }_{j = 1}^{m} {y}_{j} ( {x}_{1} , {x}_{2} , … , {x}_{n} )$$

As shown in the above formula, wherein, “xi” indicates the contract capacity in i-th time section; “n” indicates the quantity of distinguished time section (for example if there is no distinguished time section, n is equal to 1; if there are four distinguished time sections, n is equal to 4); “yj” indicates the basic charge+the penalty charge in j-th month; “m” indicates the month quantity used for evaluating the optimizing contract capacity; “z” indicates the total basic charge+the total penalty charge of the m month.

The primary objective of the present invention is to provide a set of {\acute{x}₁,\acute{x}₂, . . . , \acute{x}ₙ}, so as to allow z(\acute{x}₁, \acute{x}₂, . . . , \acute{x}ₙ)≦z(\acute{x}₁, \acute{x}₂, . . . , \acute{x}ₙ), and allow the contract exceeding months of the time section i≦ci, wherein “ci” is set by the user, the acceptable contract exceeding month maximum in i-th time section.

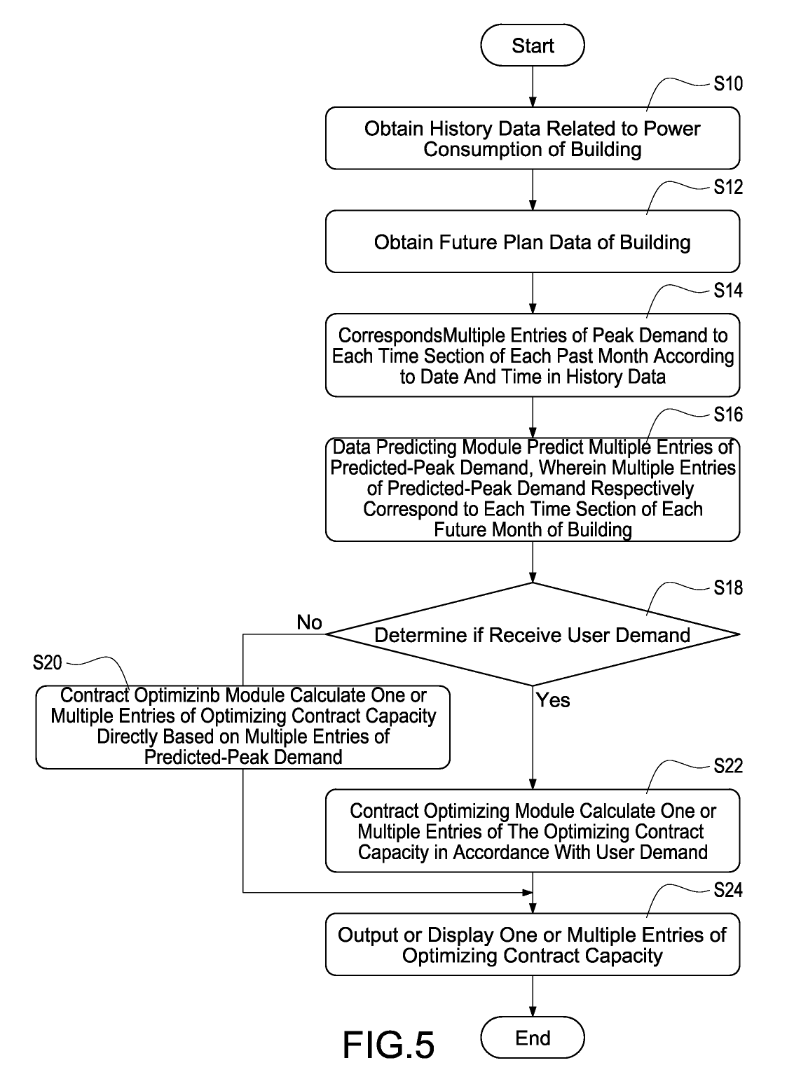

FIG. 5 is an optimizing flowchart of the first embodiment according to the present invention. The contract capacity optimizing method of the present invention is disclosed in FIG. 5. To implement the method of the present invention, firstly, the data predicting module 21 obtains the history data 31 related to power consumption of the building from the database 3 (step S10). In the embodiment, the history data 31 refers to data related to power consumption of the building last year, but is not limited thereto. Meanwhile, the data predicting module 21 obtains the future plan data 6 of the building (step S12). The future plan data 6 can be inputted by the user via the input unit 4, or saved in the database 3 in advance via other ways, but is not limited thereto. In addition, in the embodiment, the future plan data 6 refers to scheduled operation strategies of the building for executing in the following year, but is not limited thereto.

Next, the data predicting module 21 predicts the predicted-peak demand 7 of different time sections of each month of the following year in the building based on the history data 31 and the future plan data 6. In further details, if the history data 31 comprises multiple entries of the peak demand 313, the processing unit 2 respectively corresponds the multiple entries of peak demand 313 to each time section of each past month according to the date 311 and the time 312 in the history data 31 (step S14). Thus, the data predicting module 21 predicts multiple entries of the predicted-peak demand 7, wherein the multiple entries of the predicted-peak demand 7 respectively correspond to each time section of each future month of the building (step S16).

The data predicting module 21 predicts one or multiple entries of the predicted-peak demand 7, and transfers the one or multiple entries of the predicted-peak demand 7 to the contract optimizing module 22. Thus, the contract optimizing module 22 receives the user demand 8, calculates the optimizing contract capacities 9 matching with the user demand 8 and corresponding to different time sections based on the one or multiple entries of the predicted-peak demand 7.

In further details, the contract optimizing module 22 first determining if receives the user demand 8 (step S18), if not receiving the user demand 8, the contract optimizing module 22 calculates the one or multiple entries of the optimizing contract capacities 9 directly based on the one or multiple entries of the predicted-peak demand 7 (step S20). On the other hand, if receiving the user demand 8, the contract optimizing module 22 calculates the one or multiple entries of the optimizing contract capacity 9 matching with the user demand 8 based on the one or multiple entries of the predicted-peak demand 7 (step S22). Lastly, the system 1 outputs or displays the one or multiple entries of optimizing contract capacities 9 via the output unit 5 (step S24).

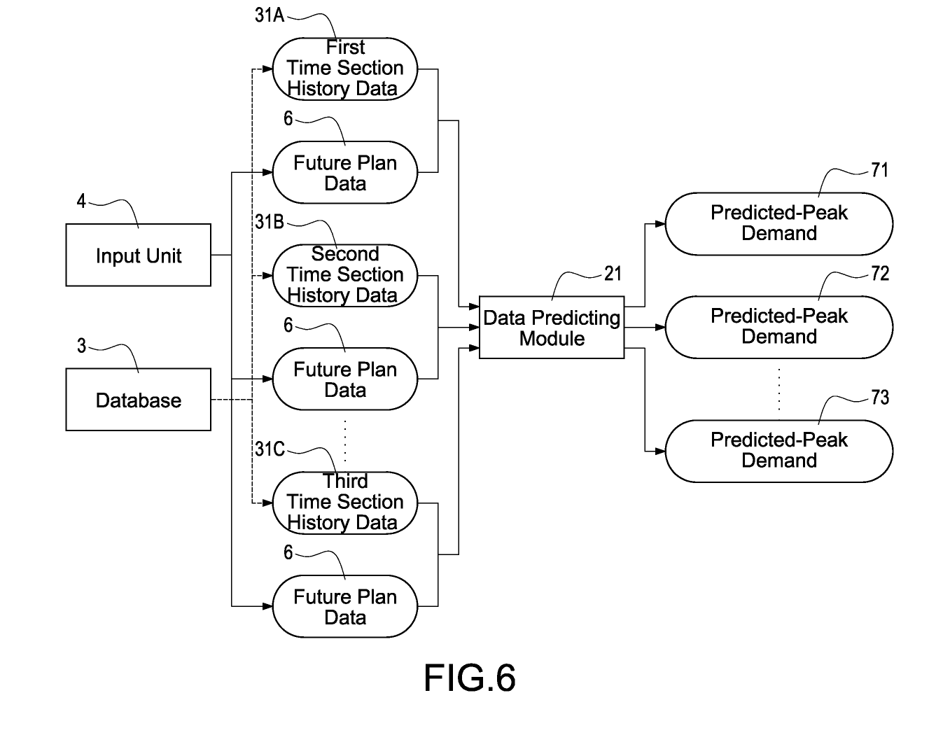

FIG. 6 is an optimizing architecture schematic diagram of the second embodiment according to the present invention. As mentioned above, the history data 31 of the database 3 respectively correspond to different time sections of each month in the past, the data predicting module 21 predicts the multiple entries of the predicted-peak demand 7 according to each time section in the future based on the history data 31 of different time section combining with the future plan data 6.

Taking the example demonstrated in FIG. 6, first time section history data 31A, second time section history data 31B, third time section history data 31C of the building . . . etc, are recorded in the database 3. The first time section history data 31A comprises information of the peak demand 313, the people count data 314, the outdoor temperature data 315, the facility launching data 316 and the other information 317 in the first time section of a certain month in the past etc. The second time section history data 31B information of the peak demand 313, the people count data 314, the outdoor temperature data 315, the facility launching data 316 and the other information 317 in the second time section of a certain month in the past, and so on.

At the same time, the data predicting module 21 receives the future plan data 6 via the input unit 4. The future plan data 6 and the history data 31A, 31B, 31C are used for predicting the multiple entries of the predicted-peak demand 7. In the embodiment, the data predicting module 21 respectively predicts a first time section predicted-peak demand 71, a second time section predicted-peak demand 72, a third time section predicted-peak demand 73. The first time section predicted-peak demand 71 corresponds to the first time section of a certain month in the following year; the second time section predicted-peak demand 72 corresponds to the second time section of a certain month in the following year, and so on. Table 2 in the following discloses an illustrative example of the predicted-peak demand 7:

TABLE 2

| | | peak time | Saturday half peak | off-peak |
|---|---|---|---|---|
| | | section | time section peak | time section |
| year | month | peak demand | demand | peak demand |
| 2013 | 1 | 2832 | 1848 | 1912 |
| 2013 | 2 | 2976 | 1832 | 1896 |
| 2013 | 3 | 2952 | 1768 | 1944 |
| 2013 | 4 | 2744 | 1848 | 1784 |
| 2013 | 5 | 2336 | 2080 | 1568 |
| 2013 | 6 | 2296 | 2080 | 1720 |
| 2013 | 7 | 2224 | 1632 | 1624 |
| 2013 | 8 | 2512 | 1616 | 1768 |
| 2013 | 9 | 2588 | 1832 | 1848 |
| 2013 | 10 | 2944 | 1984 | 1912 |
| 2013 | 11 | 3048 | 2000 | 1920 |
| 2013 | 12 | 3248 | 1968 | 2144 |

As shown in Table 2, in the embodiment, the first time section predicted-peak demand 71 corresponds to the peak time sections of each month in the following year; the second time section predicted-peak demand 72 corresponds to Saturday half peak time sections of each month in the following year; and the third time section predicted-peak demand 73 correspond to off-peak time sections of each month in the following year. Nonetheless, each country uses different billing method of electricity fees. If certain countries do not distinguish time sections in billing the electricity fee, only the history data of 12 month in the past year is recorded in the database 3, and the data predicting module 21 is used for predicting the predicted-peak demand of 12 months of the following years, without distinguishing the history data 31 and the predicted-peak demand 7 according to date, time into different time sections. The system and the method of the present invention is ready to widely applied on countries using different billing methods of electricity fees.

Lastly, the contract optimizing module 22 receives the one or multiple entries of the predicted-peak demands 71-73 predicted by the data predicting module 21, and calculates one or multiple entries of the optimizing contract capacity 9 matching with the user demand 8. In further details, if the data predicting module 21 only predicts a kind of predicted-peak demand (i.e., there is no distinguished time sections), the contract optimizing module 22 calculates only one entry of the optimizing contract capacity 9. However, if the data predicting module 21 respectively predicts multiple entries of the predicted-peak demand according to different time sections, the contract optimizing module 22 also calculates multiple entries of the optimizing contract capacity 9 based on the multiple entries of the predicted-peak demand. Also, the multiple entries of optimizing contract capacity 9 are respectively applicable to contract of each time section. For example, given the predicting results of the data predicting module 21 shown in Table 2, the contract optimizing module 22 calculates three entries of the optimizing contract capacity 9, wherein, the first entry of the optimizing contract capacity is applicable to a peak time section contract of the following year, the second entry of the optimizing contract capacity is applicable to a Saturday half peak time section contract of the following year and the third entry of the optimizing contract capacity is applicable to a off-peak time section contract of the following year. In addition, the three entries of the optimizing contract capacity 9 contributes to generating a lowest total basic charge in the future and are matching with user demand. Nonetheless, the above mentioned are preferred embodiments of the present invention, and the scope of the intention is not limited thereto.

As the skilled person will appreciate, various changes and modifications can be made to the described embodiments. It is intended to include all such variations, modifications and equivalents which fall within the scope of the invention, as defined in the accompanying claims.

What is claimed is:

1. A contract capacity optimizing system, comprising:
a database, used for recording history data related to power consumption of a building;
an input unit, used for receiving a user demand and future plan data of the building;
a processing unit, electrically coupled to the database and the input unit, the processing unit comprising:
a data predicting module, used for receiving the history data and the future plan data, as a basis for predicting a predicted-peak demand of the building in the future; and
a contract optimizing module, connecting to the data predicting module, used for receiving the predicted-peak demand and computing an optimizing contract capacity matching with the user demand based on the predicted-peak demand.

2. The contract capacity optimizing system of claim 1, wherein further comprises an output unit, electrically coupled to the processing unit, used for outputting the optimizing contract capacity.

3. The contract capacity optimizing system of claim 1, wherein the history data comprises multiple entries of peak demand, and the multiple entries of peak demand respectively correspond to each time section of each past month.

4. The contract capacity optimizing system of claim 3, wherein the data predicting module predicts multiple entries of the predicted-peak demand based on the multiple entries of the peak demand, combining with the future plan data, wherein the multiple entries of the predicted-peak demand respectively correspond to each time section of each future month.

5. The contract capacity optimizing system of claim 4, wherein the contract optimizing module respectively calculates multiple entries of the optimizing contract capacity matching with the user demand based on the multiple entries of the predicted-peak demand, wherein the multiple entries of optimizing contract capacity are respectively applicable to the contracts of different time sections.

6. The contract capacity optimizing system of claim 3, wherein the user demand is a contract exceeding month maximum acceptable to a user.

7. The contract capacity optimizing system of claim 3, wherein the history data further comprises multiple entries of the people count data, and the multiple entries of the people count data respectively correspond to each time section of each past month.

8. The contract capacity optimizing system of claim 3, wherein the history data further comprises multiple entries of the outdoor temperature data, and the multiple entries of the outdoor temperature data respectively correspond to each time section of each past month.

9. The contract capacity optimizing system of claim 1, wherein the future plan data comprises a production adjustment plan, and the production adjustment plan corresponds to a facility usage rate of the building in the future.

10. The contract capacity optimizing system of claim 1, wherein the future plan data comprises a facility adjustment plan, and the facility adjustment plan corresponds to a facility quantity and a facility performance of the building in the future.

11. The contract capacity optimizing system of claim 1, wherein the future plan data comprises a manpower adjustment plan, and the manpower adjustment plan corresponds to a total people count of the building in the future.

12. A contract capacity optimizing method, comprising:
a) obtaining history data related to power consumption of a building;
b) obtaining future plan data of the building;
c) predicting a predicted-peak demand of the building in the future based on the history data and the future plan data;
d) receiving a user demand; and
e) calculating an optimizing contract capacity matching with the user demand based on the predicted-peak demand.

13. The contract capacity optimizing system of claim 12, wherein further comprises a step f: if not receiving the user demand, calculating the optimizing contract capacity directly based on the predicted-peak demand.

14. The contract capacity optimizing system of claim 12, wherein the user demand is a contract exceeding month maximum acceptable to a user.

15. The contract capacity optimizing system of claim 12, wherein the history data comprising multiple entries of peak demand, the contract capacity optimizing method further comprises a step g: making the multiple entries of peak demand respectively correspond to each time section of each past month according to date and time; wherein in the step c, the multiple entries of the predicted-peak demand are respectively predicted based on the multiple entries of the peak demand and combining with the future plan data, wherein the multiple entries of the predicted-peak demand respectively correspond to each time section of each future month; wherein in the step e, the multiple entries of the optimizing contract capacity matching with the user demand are respectively generated based on the multiple entries of the predicted-peak demand, wherein the multiple entries of optimized contract capacity are respectively applicable to the contracts of different time sections.

16. The contract capacity optimizing system of claim 12, wherein the future plan data comprises a production adjustment plan, a facility adjustment plan and a manpower adjustment plan, the production adjustment plan corresponds to a facility usage rate of the building in the future, the facility adjustment plan corresponds to a facility quantity and a facility performance of the building in the future, the manpower adjustment plan corresponds to a total people count of the building in the future.

17. A contract capacity optimizing method, comprising:
a) obtaining history data related to power consumption of a building, wherein the history data at least comprises multiple entries of peak demand;
b) obtaining future plan data of the building;
c) making the multiple entries of the peak demand respectively corresponding to each time section of each past month according to date and time;
d) predicting multiple entries of predicted-peak demand based on the multiple entries of the peak demand in the history data, and combining with the future plan data, wherein the multiple entries of the predicted-peak demand respectively correspond to each time section of each future month;
e) determining if receiving a user demand;
f) if receiving the user demand, respectively calculating multiple entries of optimizing contract capacity matching with the user demand based on the multiple entries of the predicted-peak demand, wherein the multiple entries of optimizing contract capacity are respectively applicable to contracts of different time sections; and
g) if not receiving the user demand, respectively calculating multiple entries of the optimizing contract capacity directly based on the multiple entries of the predicted-peak demand, wherein the multiple entries of optimizing contract capacity are respectively applicable to contracts of different time sections.

18. The contract capacity optimizing method of claim 17, wherein the user demand is a contract exceeding month maximum acceptable to a user

19. The contract capacity optimizing method of claim 17, wherein the history data further comprises multiple entries of the people count data and multiple entries of the outdoor temperature data, the multiple entries of the people count data and the multiple entries of the outdoor temperature data respectively correspond to each time section of each past month, wherein in the step d, the multiple entries of the predicted-peak demand is predicted based on the multiple entries of peak demand, the multiple entries of the people count data and the multiple entries of the outdoor temperature data, and combining with the future plan data.

20. The contract capacity optimizing method of claim 19, wherein the future plan data comprises a production adjustment plan, a facility adjustment plan and a manpower adjustment plan, the production adjustment plan corresponds to a facility usage rate of the building in the future, the facility adjustment plan corresponds to a facility quantity and a facility performance of the building in the future, the manpower adjustment plan corresponds to a total people count of the building in the future.
